(19) United States
(12) Patent Application Publication
(10) Pub. No.: US 2016/0223164 A1
(43) Pub. Date: Aug. 4, 2016

(54) WALL WASHER LIGHTING SYSTEM WITH LIGHT EMITTER, OPTICAL LENS AND REFLECTOR

(71) Applicant: RAB Lighting Inc., Northvale, NJ (US)

(72) Inventor: Dan Wang-Munson, Bergenfield, NJ (US)

(21) Appl. No.: 15/012,041

(22) Filed: Feb. 1, 2016

Related U.S. Application Data
(60) Provisional application No. 62/109,837, filed on Jan. 30, 2015.

(51) Int. Cl. F21V 13/04; F21V 7/04; F21S 8/02

(52) U.S. Cl. CPC F21V 13/04; F21S 8/026; F21V 7/04; F21Y 2101/02; F21Y 2103/003

(57) ABSTRACT

A wall washer lighting system includes a light emitter mounted relative to a first surface that is about perpendicular to a second surface. The wall washer lighting system is configured to direct light from the light emitter toward the second surface. The wall washer lighting system includes an optical lens shaped to redirect light from the light emitter about uniformly along a horizontal axis of the second surface, with the horizontal axis extending to both sides of the light emitter. The wall washer lighting system also includes a reflector shaped to redirect light along a vertical axis of the second surface, the reflector uniformly shaped along its horizontal axis.

### CROSS-REFERENCE TO RELATED APPLICATIONS

This application claims the benefit of U.S. Provisional Patent Application No. 62/109,837, filed Jan. 30, 2015, and titled WALL WASHER LIGHTING SYSTEM WITH LIGHT EMITTER, OPTICAL LENS AND REFLECTOR, which is incorporated herein by reference.

### TECHNICAL FIELD

The present disclosure relates generally to wall washer lighting and, more particularly, to secondary optics for wall washer lighting.

### BACKGROUND

Wall washer lighting systems generally have an optical component focused on distributing light along a vertical plane. Traditionally, fluorescent, or linear fluorescent, lamps have been used as the light source, and a reflector is used to kick light out for a wall wash effect from the lamp. Such a reflector is designed to uniformly illuminate the wall vertically, with no special considerations taken in the horizontal plane. As a result, the horizontal distribution and, therefore, the spacing criteria (SC) of the wall washer fixture are both dependent on the natural distribution of light from the lamp in the horizontal direction. A wall washer fixture with a small SC will result in more fixtures being required to sufficiently illuminate the wall, with increased material and labor resulting from the additional fixtures that are required. A small SC may also generate hot spots, which are areas of greater light intensity, on the wall right below the fixtures.

Light emitting diodes (LEDs) have become an increasingly popular lamp source in various luminaires, including wall washers. LEDs have been recognized as providing increased efficiency and decreased costs, relative to conventional lamp sources, and also offer advantages including long life, compact size, and direct illumination. For these reasons, lighting manufacturers have used LEDs in wall washer designs and also in the design of linear wall washers. For linear wall washers, manufacturers may construct LED strips with multiple LEDs, spaced so that the LED strips physically represent linear fluorescent lamps. Despite the many previously-discussed advantages of using LEDs in wall washer systems, LED wall washers encounter the same issues as fluorescent wall washers with regard to lighting distribution, spacing criteria, and hot spots.

Therefore, it is desirable to provide a wall washer system with increased efficiency and decreased costs, relative to conventional lamp sources, as well as providing uniform lighting distribution, increased spacing criteria, and elimination of hot spots. The present disclosure is responsive to such an endeavor and is directed to one or more of the problems or issues set forth above.

### SUMMARY OF THE DISCLOSURE

In one aspect, a wall washer lighting system includes a light emitter mounted relative to a first surface that is about perpendicular to a second surface. The wall washer lighting system is configured to direct light from the light emitter toward the second surface. The wall washer lighting system includes an optical lens shaped to redirect light from the light emitter about uniformly along a horizontal axis of the second surface, with the horizontal axis extending to both sides of the light emitter. The wall washer lighting system also includes a reflector shaped to redirect light along a vertical axis of the second surface, the reflector uniformly shaped along its horizontal axis.

### BRIEF DESCRIPTION OF THE DRAWINGS

FIG. 1 is an elevational view in partial section depicting an exemplary embodiment of a wall washer lighting system, according to one aspect of the present disclosure;

FIG. 2 is a side view in partial section of a light emitter and optical lens of the wall washer lighting system of FIG. 1;

FIG. 3 is a front perspective view of the optical lens of FIGS. 1 and 2;

FIG. 4 is a back perspective view of the optical lens of FIGS. 1 and 2; and

FIG. 5 is a bottom perspective view of an exemplary linear wall washer lighting system including a plurality of linearly aligned light emitters, according to another aspect of the present disclosure.

### DETAILED DESCRIPTION

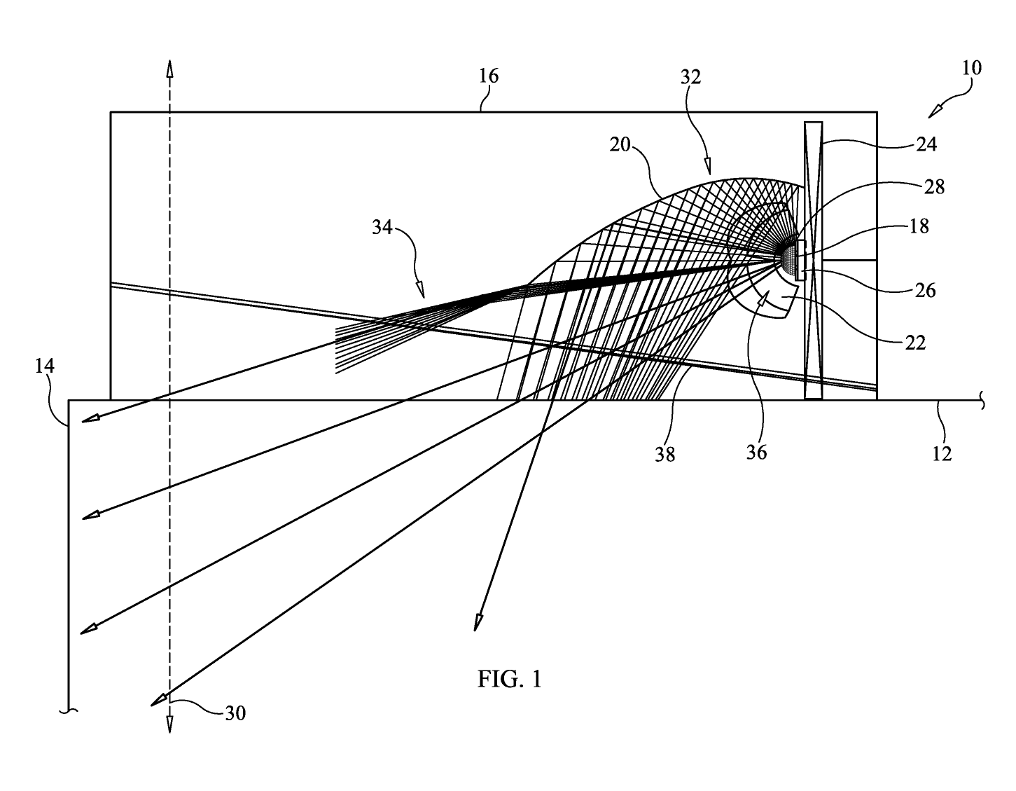

Referring to FIG. 1, there is shown an elevational view of a wall washer lighting system 10, according to an exemplary embodiment of the present disclosure. The exemplary wall washer lighting system 10 is shown mounted relative to a first surface 12, such as a ceiling, which is about perpendicular to a second surface 14, such as a wall. The wall washer lighting system 10 is configured to direct light from one or more light sources, examples of which will be provided below, toward the second surface 14.

The wall washer lighting system 10 may generally include a housing 16, such as a rectangular shaped housing, supporting and/or protecting at least a light emitter 18, a reflector 20, and an optical lens 22. According to the exemplary embodiment, the housing 16 is configured to support the wall washer lighting system 10 relative to the first surface 12. For example, when properly installed, the housing 16 may support the light emitter 18, reflector 20, and optical lens 22 above, or recessed relative to, the first surface 12. Additional components, such as fasteners and the like, may be required to secure the position of the housing 16 relative to the first surface 12.

The light emitter 18 may be supported within the housing 16 at a position and orientation for directing light from the light emitter 18 toward the second surface 14. For example, a vertical support structure 24 may be provided within the housing 16 and may provide a surface for mounting the light emitter 18. As shown, the light emitter 18 may have a vertical orientation when secured to or mounted on the support structure 24.

The light emitter 18 may be, but is not limited to, an LED emitter commonly used in commercial lighting in combination with a driver. Alternatively, for example, the light emitter 18 may be a laser diode or other alternative diode light source. The light emitter 18 may include a single chip containing one or more light sources or may include multiple chips. According to the example provided, the light emitter 18 may be provided on a substrate 26, or chip, and may include a primary optic 28 for protecting and/or shaping the light output of the light emitter 18. The primary optic 28 may, according to some embodiments, have a semi-circular shape. The light emitter 18, according to the exemplary embodiment, may also be referred to as a planar light emitter.

The reflector 20 may be shaped to redirect light along a vertical axis 30 of, or parallel to, the second surface 14. More specifically, the reflector 20 may be shaped to redirect, or reflect, light from the light emitter 18 and distribute it vertically along the second surface 14. The position, including orientation, of the light emitter 18, relative to the second surface 14, along with the configuration of the reflector 20, are all selected based on a desired vertical light intensity distribution or wall wash effect provided by the wall washer lighting system 10.

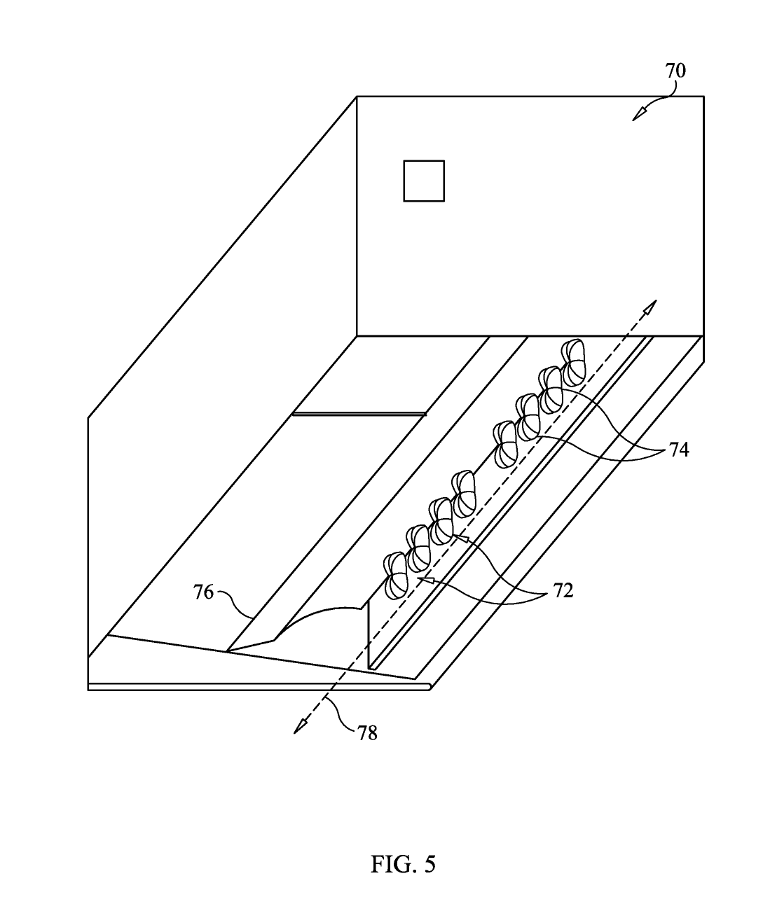

The reflector 20 may include a first segment 32 closest to the light emitter 18 that is curvilinear and a second segment 34 furthest from the light emitter 18 that is about flat, or linear. The first segment 32 may be shaped to redirect light downward and toward a lower portion of the second surface 14, while the second segment 34 may be shaped to redirect light toward an upper portion of the second surface 14. It should be appreciated that, since the exemplary light emitter 18 is directional (i.e., illuminating only 180 degrees), light is only being emitted from a light emitting side 36 of the substrate 26. Some portions of the light need not be redirected and, thus, may be emitted directly from the light emitter 18 toward the second surface 14 and, possibly, a lower surface, or floor. As will be discussed below with reference to FIG. 5, the reflector 20 may be uniformly shaped along its horizontal axis.

The optical lens 22 may be shaped to redirect light from the light emitter 18 about uniformly along a horizontal axis of the second surface 14, as will be described below. The optical lens 22 may be positioned over the primary optic 28 and, therefore, may be referenced as a secondary optic. In addition, a transparent cover 38 may be provided to enclose the housing 16 and protect the components therein. As shown, the transparent cover 38 may be angled relative to the first surface 12.

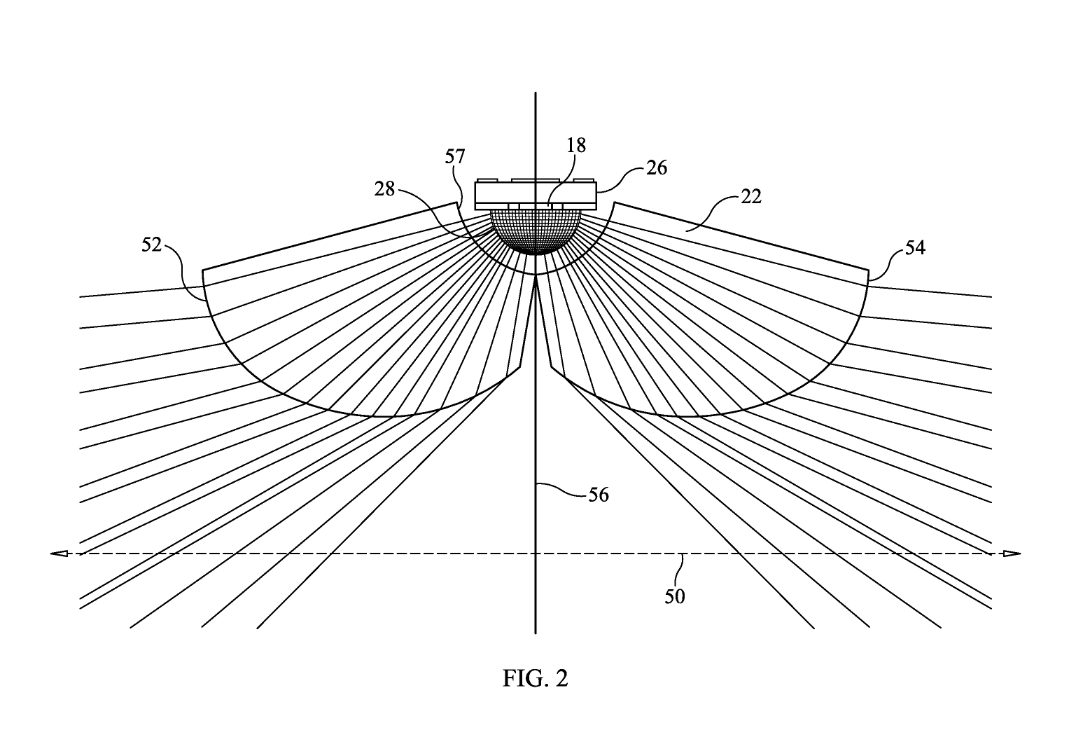

Turning now to FIG. 2, the optical lens 22 will be discussed in greater detail. As stated above, the optical lens 22 may be shaped to redirect light from the light emitter 18 about uniformly along a horizontal axis 50 of the second surface 14. As shown, the optical lens 22 may have at least two lobes 52 and 54, with each of the lobes 52 and 54 being positioned on either side of a centerline 56 through the light emitter 18 and having a generally convex surface shaped to achieve a greater intensity distribution in the horizontal plane than what would be achieved without the optical lens 22. That is, the optical lens 22 may be shaped to redirect light away from the centerline 56 to increase the light intensity distribution in the horizontal plane.

An inner surface 57 of the optical lens 22 may have a shape matching that of the primary optic 28 or may have an alternative shape. According to some embodiments, the inner surface 57 may be shaped to contribute to the horizontal distribution of the light.

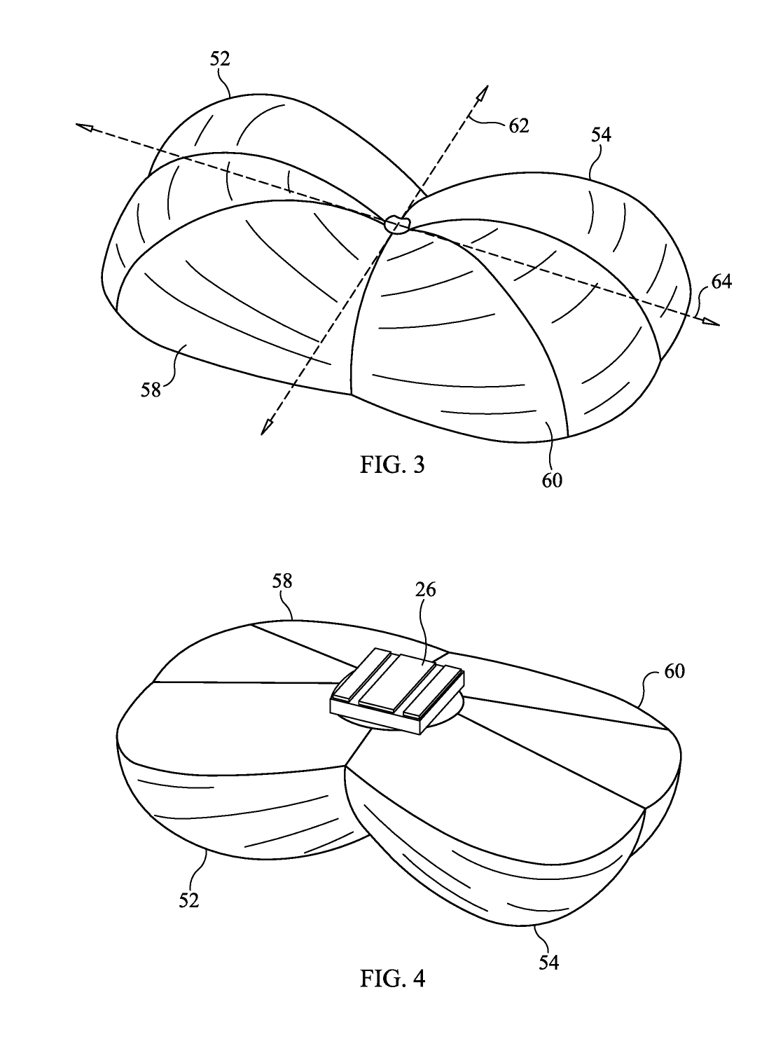

According to the exemplary embodiment, the optical lens 22 may have four lobes 52, 54, 58, and 60 and two axes 62 and 64 of symmetry, as shown in FIGS. 3 and 4. Although a specific embodiment is shown, it should be appreciated that alternative embodiments, including different lens configurations, may be substituted for the exemplary embodiment. The optical lens 22 of the preferred embodiment is designed to be made of acrylic, however the optical lens 22 could be make of any material with high light transmittance, including, for example, polycarbonate, resin, and glass. The surface of the optical lens 22 may be smooth or textured.

Turning now to FIG. 5, an exemplary linear wall washer lighting system 70 is shown. The linear wall washer lighting system 70 is similar to the wall washer lighting system 10 described above; however, the linear wall washer lighting system 70 includes a plurality of linearly aligned light emitters 72, with each of the linearly aligned light emitters including a separate optical lens 74. A single reflector 76 may be provided for the linear wall washer lighting system 70. As mentioned above, the reflector 76 may be uniformly shaped along its horizontal axis 78. In addition, the reflector 76 may have a length corresponding to the number of light emitters used.

The wall washer lighting system 10 of the present disclosure provides increased horizontal distribution of light transmitted from the wall washer. As such, a larger spacing criteria is provided, requiring less fixtures, which results in less material and labor. Further, since the spacing criteria is greater, less hot spots are generated. As a result, the wall washer lighting system 10 of the present disclosure provides a more uniform lighting distribution with increased efficiency and decreased costs.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A wall washer lighting system, comprising:
a light emitter mounted relative to a first surface that is about perpendicular to a second surface, the wall washer lighting system configured to direct light from the light emitter toward the second surface;
an optical lens shaped to redirect light from the light emitter about uniformly along a horizontal axis of the second surface, the horizontal axis extending to both sides of the light emitter; and
a reflector shaped to redirect light along a vertical axis of the second surface, the reflector uniformly shaped along its horizontal axis.

2. The wall washer lighting system of claim 1, wherein the reflector includes a first segment closest to the light emitter that is curvilinear and a second segment furthest from the light emitter that is about flat.

3. The wall washer lighting system of claim 1, wherein the light emitter, the optical lens, and the reflector are recessed relative to the first surface.

4. The wall washer lighting system of claim 1, wherein the optical lens has at least two lobes.

5. The wall washer lighting system of claim 1, wherein the optical lens has two axes of symmetry.

6. The wall washer lighting system of claim 1, further including a plurality of linearly aligned light emitters.

7. The wall washer lighting system of claim 6, wherein each of the linearly aligned light emitters includes a separate optical lens.
